(19) United States
(12) Patent Application Publication
(10) Pub. No.: US 2020/0110582 A1
(43) Pub. Date: Apr. 9, 2020

(54) ARITHMETIC PROCESSING DEVICE FOR RESOLVER SIGNAL

(71) Applicant: TAIYO YUDEN CO., LTD., Tokyo (JP)

(72) Inventors: Mitsunori KATSU, Tokyo (JP); Shoichi SEKIGUCHI, Tokyo (JP); Iwao FUJIKAWA, Tokyo (JP)

(73) Assignee: TAIYO YUDEN CO., LTD., Tokyo (JP)

(21) Appl. No.: 16/611,750

(22) PCT Filed: May 9, 2018
(86) PCT No.: PCT/JP2018/017852

§ 371 Date: Nov. 7, 2019

(30) Foreign Application Priority Data
May 11, 2017 (JP) 2017-094351

(51) Int. Cl. G06F 7/57; G01D 5/20

(52) U.S. Cl. CPC G06F 7/57; G01D 5/20

(57) ABSTRACT

An arithmetic processing device for resolver signal including: an A/D converter for converting a rotation detection signal of a rotation detection sensor supplied from the outside into a digital signal; and a logic unit constituting a logic circuit that calculates the angle of the script detection sensor from the digital signal output from the A/D converter, wherein the amplifier, the A/D converter, and the logic unit are mounted in the same chip or in the same package.

### TECHNICAL FIELD

The present invention relates to an arithmetic processing device for resolver signals.

### BACKGROUND ART

The resolver system includes a rotation detection sensor, which is also called a resolver, and a digital converter which converts an analog signal output from the resolver into a digital signal and calculates a rotation angle. The resolver is an angle sensor that outputs the rotation angle of the rotation detector coupled to the monitored object as a two-phase AC voltage (analog signal). The digital converter converts the analog signal output from the resolver into a digital signal and detects it as a rotation detection signal, converts the rotation detection signal into an angle value, and digitizes the angular position of the monitoring object with the digitized angle value It makes it output (patent Literature 1).

In addition, processing speed, noise resistance and reliability can be improved, and cost can be reduced by integrating the R/D converter that is the resolver interface with hardware such as a microcomputer and DSP (Digital Signal Processor). An arithmetic processing unit for a resolver signal, which has been developed, has also been proposed (Patent Literature 2).

### PRIOR ART DOCUMENT(S)

Patent Literature(s)

Patent literature 1: Japanese Patent Application Laid-open Publication No. 2008-219756

Patent literature 1: Japanese Patent Application Laid-open Publication No. 2002-350180

### SUMMARY OF THE INVENTION

### Problems to be Solved by the Invention

In a resolver digital converter provided separately with an analog circuit, a discontinuity occurs at ±90° in the arc tangent of the resolver angle. Therefore, the tracking loop circuit which is an analog circuit was required.

The embodiment which solves the mentioned subject is illustrated by the following item sets.

1. An arithmetic processing device for resolver signal comprising:

an A/D converter for converting a rotation detection signal of a rotation detection sensor supplied from the outside into a digital signal; and

a logic unit constituting a logic circuit that calculates the angle of the script detection sensor from the digital signal output from the A/D converter,

wherein the amplifier, the A/D converter, and the logic unit are mounted in the same chip or in the same package.

2. The arithmetic processing device according to item 1, comprising an excitation coil, a first detection coil and a second detection coil that detect a signal according to an excitation signal of the excitation coil, wherein the first and second detection coils have a 90° phase with each other offset and located around the excitation coil;

wherein the A/D converter converts an analog signal S1 transmitted from the first detection coil and an analog signal 82 generated from the second detection coil into a digital signal S1 and a digital signal S2, respectively; and

wherein the logic unit obtains the accuracy (θ) of the exciting coil with respect to the digital signals S1 and S2 according to the following equation (where t is time, f (t) is an excitation signal, and ω is an angular velocity).

S1=sin θ·f(t)=sin θ·sin ωt

S2=cos θ·f(t)=cos θ·sin ωt

θ=tan−1(sin θ/cos θ)

3. The arithmetic processing device according to item 1 or 2, further comprising an amplifier for amplifying the rotation detection signal with a designated gain,

wherein the logic unit transmits a signal for setting the designated gain to the amplifier in accordance with an analog signal voltage of a rotation detection sensor.

4. The arithmetic processing device according to any of items 1 to 3, wherein the logic unit includes a plurality of address lines, a plurality of data lines, a memory cell unit, and an address decoder that decodes an address signal and outputs a decode signal to the memory cell unit.

5. The arithmetic processing device according to item 4, wherein the memory cell unit controls or sets the amplification unit as a wiring element and/or a logic element configured by truth table data.

6. The arithmetic processing device according to item 4 or 5, wherein the memory cell unit calculates an angle from a digital signal output from the A/D converter as a wiring element and/or a logic element configured by truth table data.

7. The arithmetic processing device according to any of items 1 to 6, wherein the logic unit is a multi-lookup table.

### Effect of the Invention

The programmable device according to the present embodiment can calculate the angle with a digital circuit without requiring a tracking loop circuit that is an analog circuit.

### BRIEF DESCRIPTION OF THE DRAWINGS

FIG. 1A illustrates a first example of a programmable device for a rotation detection sensor;

FIG. 1B illustrates a first example of a programmable device for a rotation detection sensor;

FIG. 2A is a diagram illustrating the configuration of a resolver;

FIG. 2B is a diagram illustrating the relationship between an excitation signal and digital signals S1 and S2;

FIG. 3 is a diagram illustrating an example of the entire configuration of an MRLD;

FIG. 4 is a view schematically illustrating an MLUT configured by horizontally stacking MLUTs;

FIG. 5 is a diagram illustrating an example of an MLUT;

FIG. 6 is an example of an MLUT to which a synchronization circuit is applied;

FIG. 7 is a diagram illustrating an example of an MLUT;

FIG. 8 is a diagram illustrating an example of an MLUT operating as a logic circuit;

FIG. 9 is a diagram illustrating a truth table of the logic circuit shown in FIG. 8;

FIG. 10 is a diagram illustrating an example of an MLUT operating as a connection element;

FIG. 11 is a diagram illustrating a truth table of the connection element shown in FIG. 10;

FIG. 12 illustrates an example in which one MLUT operates as a logic element and a connection element; and

FIG. 13 illustrates a truth table of logic elements and connection elements.

### MODE FOR CARRYING OUT THE INVENTION

Hereinbelow, in order to explain the present embodiment, referring to the drawings, programmable device, 2. MRLD, 3. MLUT, 4. A method of generating configuration data of the programmable device will be described in order.

1. Arithmetic Processing Unit for Resolver Signal

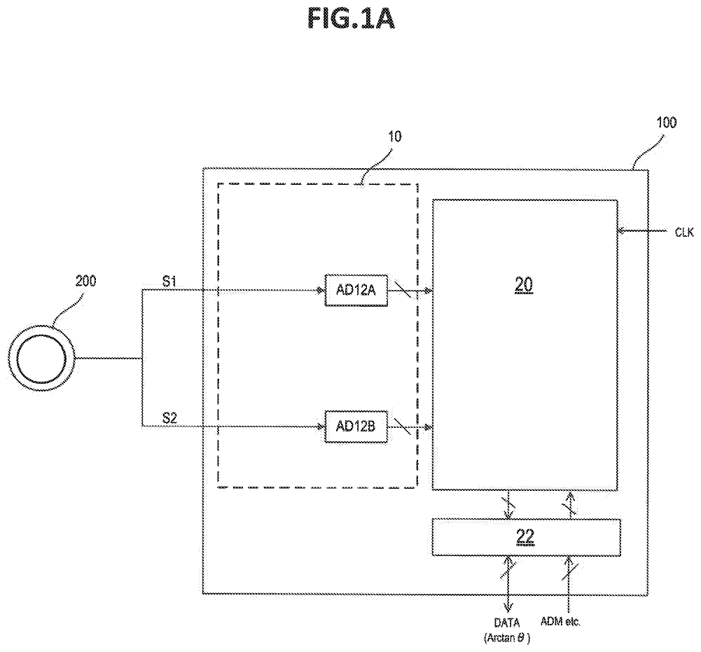

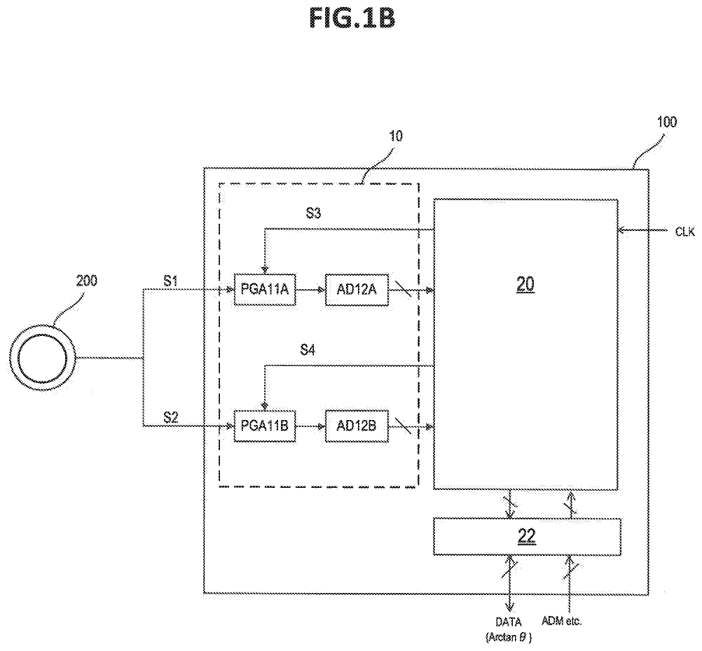

FIG. 1A is a diagram illustrating an example of a programmable device for a rotation detection sensor. The resolver signal processing unit 100 includes an analog unit 10, a logic unit 20, and a configuration unit 22, and is connected to the resolver 200.

The analog unit 10 includes analog-to-digital converters (AD) 12A and 12B.

The logic unit 20 is an electronic circuit that handles digital signals and is also called a logic circuit. One aspect of the logic unit 20 is an MRLD (Memory based Reconfigurable Logic Device) (registered trademark) described later.

The configuration unit 22 is an interface circuit that reads or writes configuration data of the logic unit 20. The configuration unit 22 inputs configuration data from the bus of the external terminal and writes the configuration data to the MLUT described later.

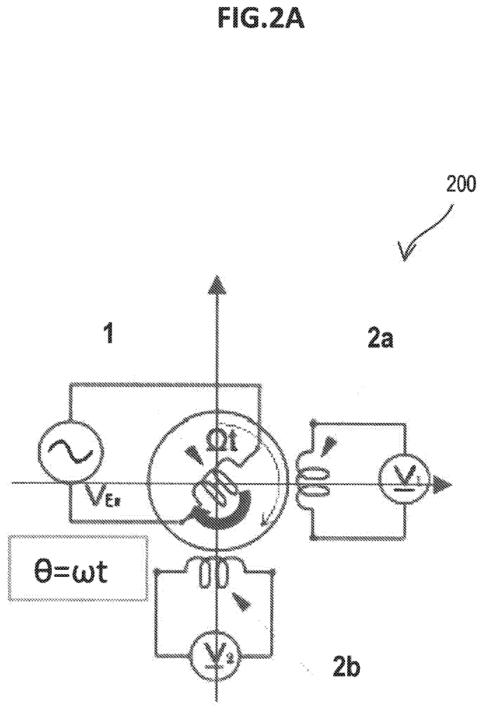

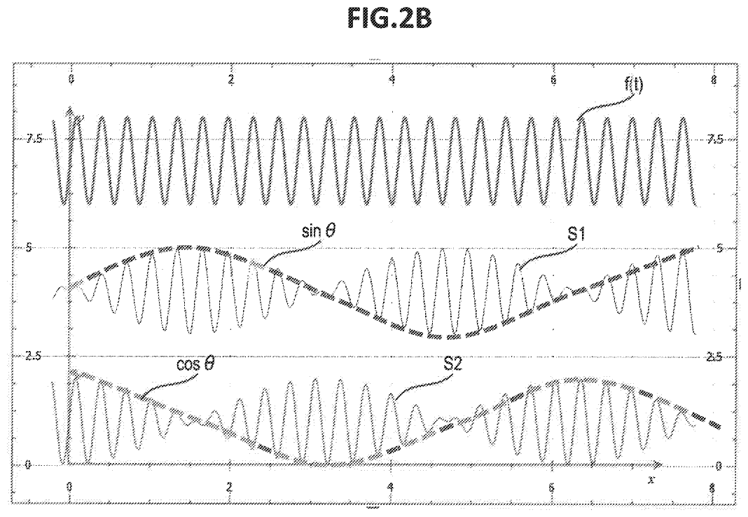

FIG. 2A is a diagram illustrating the configuration of a resolver. The resolver 200 includes an excitation coil (rotor) 1 and detection coils 2a and 2b. The detection coils 2a and 2b are 90° out of phase with each other. When an excitation signal is supplied to the excitation coil 1, the detection coils 2a and 2b generate analog signals, which are supplied to the arithmetic processing unit 100 for resolver signals.

The analog-to-digital converters (AD) 12A and 12B receive the signals S1 and S2, respectively. The analog signals S1 and 82 are converted into digital signals S1 and S2, and the digital signal is sent to the logic unit 20.

The logic unit 20 generates waveforms of sin θ and cos θ from the digital signals of S1 and S2, respectively. FIG. 2B is a diagram illustrating the relationship between the excitation signal and the digital signals S1 and S2. The rotation angle of the excitation coil is θ, and the excitation signal f (t).

The logic unit 20 generates sin θ and cos θ from the digitized signals S1 and S2 by the following calculation.

S1=sin θ·f(t)=sin θ·sin ωt

S2=cos θ·f(t)=cos θ·sin ωt

θ=tan−1(sin θ/cos θ)

Here, θ represents a rotation angle, t is time, and ω is an angular velocity.
The rotation angle (θ) of the resolver 200 can be calculated by calculating arctangent from the arithmetically processed sin θ and cos θ. The arc tangent has a discontinuity at ±90°. The discontinuities are caused by analog processing of arctangent, and in order to avoid this, in the prior art, using tracking loop circuits, phase adjustment is performed to obtain a continuum point from the previous time phase, and the discontinuities are calculated. Lost

However, in the present embodiment, since the analog-to-digital converters 12A and 12B digitize continuous analog signals, discontinuities do not occur in the digitized data. Thereby, the resolver rotation angle is continuously calculated. Therefore, according to the method, it is not necessary to configure the tracking loop circuit with the logic unit 20.

The logic unit 20 can be programmed with configuration data as described later and can output not only the input from the analog unit 10 but also the signal to the analog unit 10. Therefore, the gain setting of the PGAs 11A and 11B is also possible from the logic unit 20.

Since the logic unit 20 is a logic circuit, the operation s faster than a central processing unit (CPU). Since the CPU operates in conjunction with the cache memory and the main memory, the operation is delayed compared to the logic circuit by the access to the cache memory/main memory. On the other hand, even if the clock is operated, a continuous operation cannot be performed essentially due to a cache miss or the like.

Therefore, the operation by the CPU is inferior to the analog processing of the tracking loop circuit in the speed or reliability of continuous data generation. However, the programmable device according to the present embodiment can operate at high speed and continuously because the logic unit, not the CPU, constitutes the logic circuit and operates in synchronization with the clock.

An arctangent signal (Arctan) Indicating the rotation angle can be output to the outside through the configuration unit 22.

FIG. 1B is a diagram illustrating a second example of a programmable device for a rotation detection sensor. The processing unit 100 for the resolver signal shown in FIG. 2B is different from FIG. 2A in that the analog unit 10 further includes programmable gain amplifiers (PGA) 11A and 11B.

The PGAs 11A and 11B receive S1 and S2, respectively, and amplify the voltage of the analog signal to the input voltage of the AD 12A or 12B in the subsequent stage. The PGAs 11A and 11B are amplifiers whose gain can be changed. The gains of the PGAs 11A and 11B are changed according to the digital signals S3 and S4 from the logic unit 20. In this manner, the PGA enables the arithmetic processing unit 100 for resolver signals to be compatible with various resolvers 200.

As described above, the programmable device for a rotation detection sensor according to this embodiment can output the rotation angle of the resolver continuously by calculating the digitally converted resolver signal with the logic circuit formed by the logic unit. As described above, the resolver signal arithmetic processing unit 100 can calculate the angle from any resolver 200 analog signal.

2. MRLD Configuration

2.1 Overall Configuration of MRLD

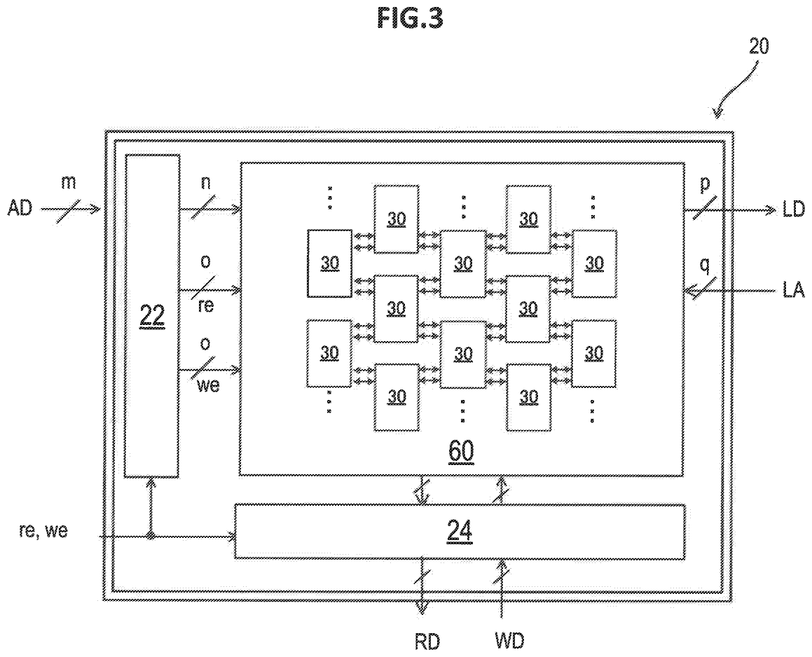

20 shown in FIG. 3 is an example of the MRLD. The MRLD 20 has an MLUT array 60 in which a plurality of MLUTs 30 using synchronous memory units are arranged in an array, a row decoder 22 specifying a memory read operation and a write operation of the MLUT 30, and a column decoder 24.

The MLUT may be comprised of a synchronous memory unit. A memory element of the memory stores data regarded as a truth table, and the MLUT performs a logic operation operating as a logic element, or a connection element, or a logic element and a connection element. The synchronous memory unit described here is an embodiment of the MLUT, and for example, the MLUT may be composed of an OTP ROM (One Time Programmable ROM) which can be written only once and cannot be erased.

The logic operation of the MRLD 20 uses the signals of the logic address LA and the logic data LD indicated by solid lines. The logic address LA is used as an input signal of the logic circuit. The logic data LD is used as an output signal of the logic circuit. In the MRLD array 60, the logic address LA and the logic data LD are used as signal lines for connecting the MLUTs. Connected

The logic implemented by the logic operation of MRLD 20 is implemented by truth table data stored in MLUT. Some MLUTs operate as logic elements as combinational circuits such as AND circuits, adders and the like. The other MLUTs operate as connection elements connecting between the MLUTs that realize the combinational circuit. Rewriting of the truth table data for the MLUT to realize the logic element and the connection element is performed by a write operation to the memory.

The write operation of the MRLD 20 is performed by the memory operation address AD and the write data WD, and the read operation is performed by the memory operation address AD and the read data RD.

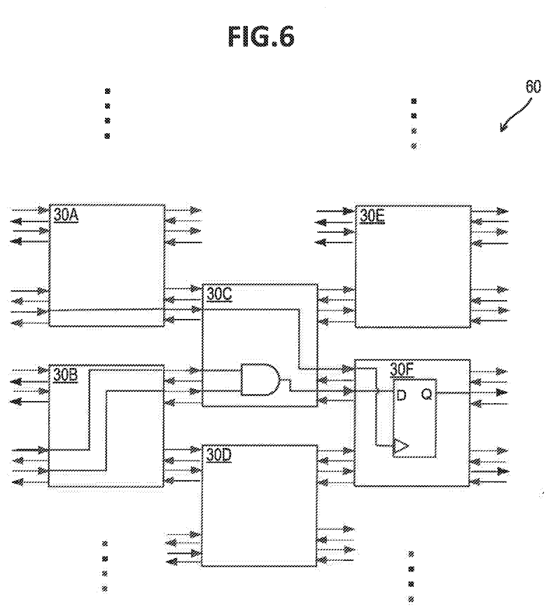

The memory operation address AD is an address for specifying a memory cell (described later in FIG. 6 and the like) in the MLUT and is used in both the read operation and the write operation of the memory. The memory operation address AD specifies the memory cell of the number n of 2 m to the m signal lines. The row decoder 22 receives the MLUT address via m signal lines and decodes the MLUT address to specify a memory cell in the MLUT to be subjected to a memory operation. In the present embodiment, although described later, decoding of the logic address LA is performed by a decoder in the MLUT.

The row decoder 22 decodes x bits among the m bits of the memory operation address AD according to control signals such as the read enable signal re and the write enable signal we, and outputs the decoded address n to the MLUT 30. Decode address n is used as an address for specifying a memory cell in MLUT 30.

Column decoder 24 decodes y bits out of m bits of memory operation address AD, and has the same function as row decoder 22 and outputs decode address n to MLUT 30 and write data WD and read data RD.

When the array of MLUTs is a rows and t columns, data of n×t bits is input from the MLUT array 60 to the column decoder 24. Here, in order to select the MLUT for each row, the row decoder 22 outputs re and we for o rows. That is, o row corresponds to s row of MLUT. Here, a word line of a specific memory cell is selected by activating only one bit of o bits. Since t MLUTs output n bits of data, n×t bits of data are selected from the MLUT array 60, and the column decoder 24 is used to select one of them.

2.2 Bidirectional MLUT Arrangement

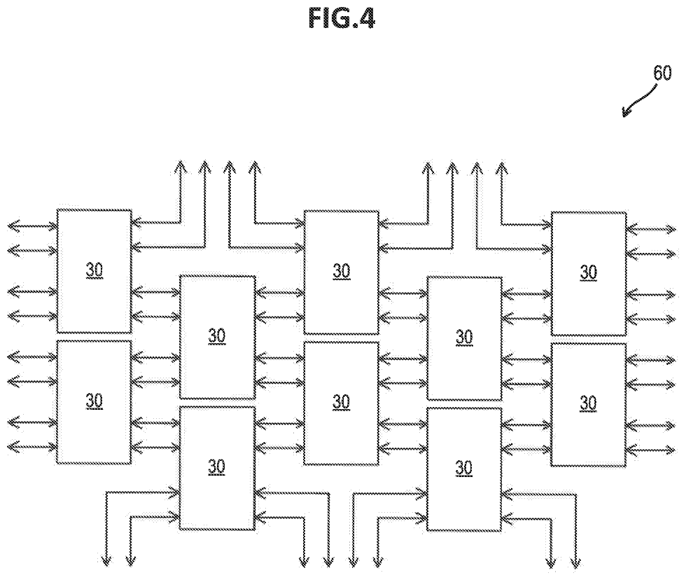

FIG. 4 is a diagram schematically illustrating the MLUT array 60 configured by laterally stacking the MLUTs 30. As shown in FIG. The MLUT array 60 is an array of MLUTs 30 as illustrated. The memory used as the MLUT 30 has the same address line width and data line width. A pseudo bi-directional line is defined by pairing each bit of the address line and the data line. This pseudo bi-directional line is called “AD pair”. In FIG. 4, a bi-directional line is indicated by a bi-directional arrow, and a bi-directional line of 4-bit data line width is shown. By using a memory having an address line width and a data line width of N bits, an MLUT having N AD pairs is realized.

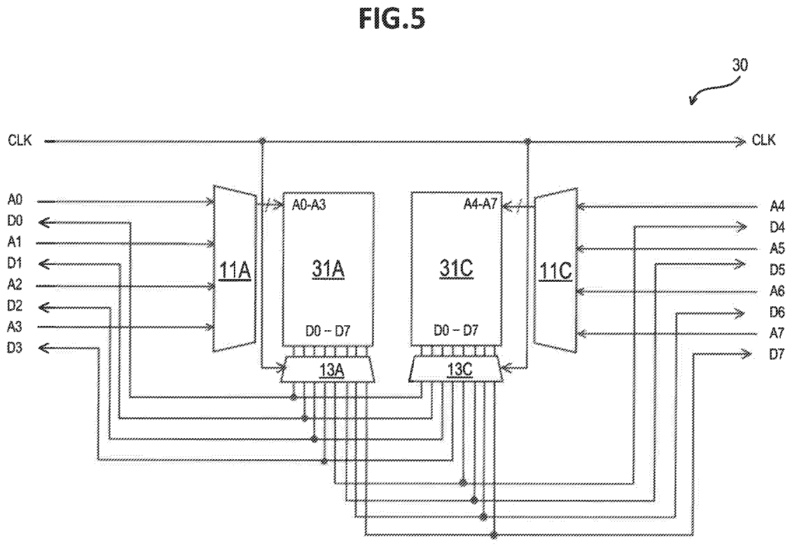

FIG. 5 is a diagram illustrating an example of an MLUT having an 8-bit data line width. Although FIG. 4 illustrates a bidirectional arrow, FIG. 5 illustrates an address line and a data line respectively by a unidirectional arrow. The MLUT 30 illustrated in FIG. 4 is the inputs of the addresses A0L to A7L (an example of address LA for logic, and same as below) illustrated in FIG. 5 from the left direction, and the inputs of the addresses A0R to A7R illustrated in FIG. 5 from the right direction, and the outputs of the data D0L to D7L shown in FIG. 5 (an example of the data for logic LD, same as below) illustrated in FIG. 5 to the right direction. The MLUT with n value=8 becomes 1 M bit in the conventional method, and the CLB (Configurable Logic Blocks) equivalent is enlarged to 4 M bit. On the other hand, the MLUT according to the present embodiment is configured by 4K (256 words×16 bits) bits×2 as described later.

In the MLUT, output data of a memory cell unit is connected to input data of another memory cell unit. In addition, since a memory cell unit can use a large memory such as a static random-access memory (SRAM), input/output lines can be increased.

MLUT 30 further includes address decoders 11A and 11C and output buffers 13A and 13C. Although not shown, a selection circuit for switching between the logic address LA and the memory operation address AD is provided at the front stage of the address decoders 11A and 11C. The output buffers 13A and 13C are selection circuits for switching the output data D0 to D7 or the read data RD, and operate as buffers for temporarily holding the output data in accordance with the clock (CLK).

3. MLUT

FIG. 6 is a diagram illustrating an example of a circuit diagram of the MLUT.MLUT 30 includes memory cell units 31A and 31C. In FIG. 6, the MLUT array 60 shown In FIG. 6 includes the MLUTs 30A to 30E, which are connected by input address lines or output data lines shown by unidirectional arrows. In the example illustrating the configuration data shown in FIG. 6, the MLUT 30A and the MLUT 30B are configured as connection circuits connected to the MLUT 30C. The MLUT 30C is a connection circuit connected to the MLUT 30F and constitutes an AND circuit. The MLUT 30F is configured as an output buffer described later.

3.1 Output Buffer

The output buffers 13A and 13C (13A to 13D in the second example described later). The same applies to the following) reads out data from the data line of the memory cell unit in synchronization with the clock and holds it to provide the function of the FF (flip flop). That is, by maintaining the Q output of the FF in the I/O buffer and realizing the connection relationship with the logic circuit in the previous stage with the truth table data, the MLUT composed of the synchronous memory unit can provide the FF function. Output buffers 13A and 13C each include a sense amplifier for amplifying a voltage output from a bit line of a memory cell. The asynchronous MLUT that receives the clock output from the delay element also has an I/O buffer. However, since the asynchronous MLUT is used for combinational logic, it is used not to configure the FF. For synchronous operation, see “3. MLUT Logic, Connection, and Synchronization Operations”.

3.2 Synchronous Operation Using Output Buffers

In the synchronous design, the delay time is synchronized with the maximum clock time so as to be comprehensively within the clock period, and since the circuit is configured within such timing constraints, the delay times of the wiring and the LUT are not affected. In this way, synchronization waits for the clock occur in units of LUs (Logic Units) that configure the FPGA, and each synchronous latency is added In series as a whole of the FPGA, which slows down the operation speed of the FPGA.

In the synchronous design of MRLD, a clock is inserted in the memory unit for synchronization in the opposite direction (also referred to as back-forwarding) as that of the asynchronous memory unit to avoid a malfunction due to a wiring delay. Calculated from the specifications of the memory IP, the maximum time for accessing memory data is taken as the delay amount.

4. MLUT Logic, Connection, and Sequential Circuit Operation

The logic, connections, and synchronization operations of the MLUT will be described below using an example. In the above description, there are eight addresses or data for the addresses of the MLUT 30 at A0 to A7 and the output data at D0 to D7, respectively, but here four addresses for simplification of the description. Or explain with data.

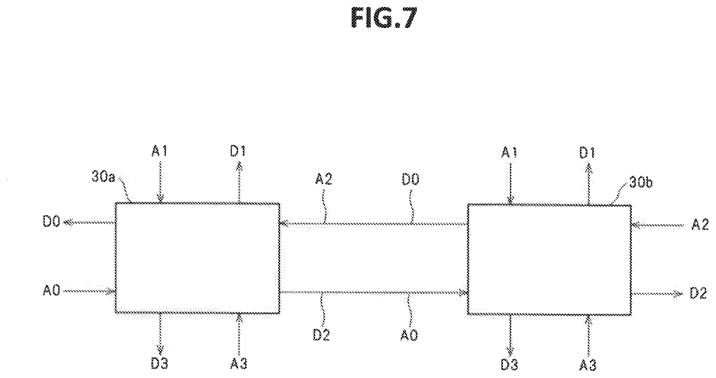

FIG. 7 is a diagram illustrating an example of the Mutate MLUTs 30a and 30b shown in FIG. 7 are connected to four addresses A0 to A3 and four output data D0 to D3. The address A2 of the MLUT 30a is connected to the output data D0 of the adjacent MLUT 30b, and the MLUT 30a receives the data for logic output from the MLUT 30b as a logic address input. The output data D2 of the MLUT 30a is connected to the address A0 of the MLUT 30b, and the logic data output from the MLUT 30a is received by the MLUT 30b as a logic address input.

The configuration data (truth table data) for realizing the circuit configuration shown below with MLUT is that of MLUT 30a or 30b shown in FIG.

A. Truth Table Data Constituting Logic Circuit

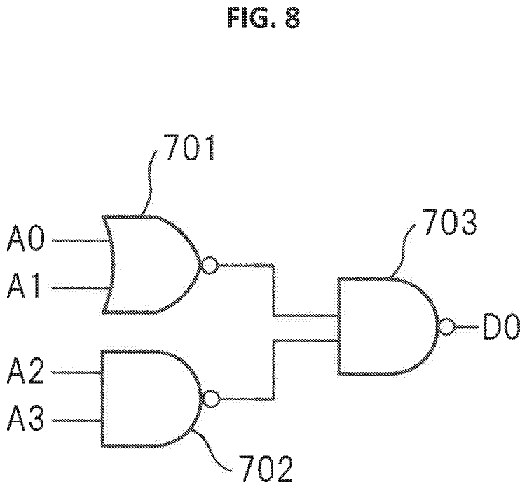

FIG. 8 is a diagram illustrating an example of the MLUT operating as a logic circuit. In this example, the addresses A0 and A1 are input to the 2-input NOR circuit 701, and the addresses A2 and A3 are input to the 2-input NAND circuit 702. The output of the 2-input NOR circuit 701 and the output of the 2-input NAND circuit 702 are input to the 2-input NAND circuit 703, and a logic circuit is configured to output the output of the 2-input NAND circuit 703 to the output data D0.

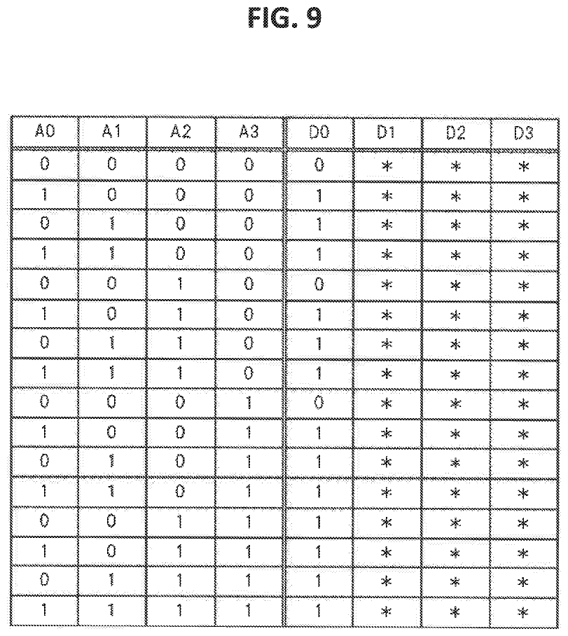

FIG. 9 is a diagram illustrating a truth table of the logic circuit shown in FIG. 8. The logic circuit of FIG. 8 uses all the inputs of the inputs A0 to A3 as inputs because of four inputs. On the other hand, since the output is one, only the output D0 is used as the output. In the columns of the outputs D1 to D3 of the truth table, “*” is described. This indicates that the value may be either “0” or “1”. However, when truth table data is written to the MLUT for reconstruction, it is necessary to write either “0” or “1” to these fields.

B. Truth Table Data Constituting Connection Circuit

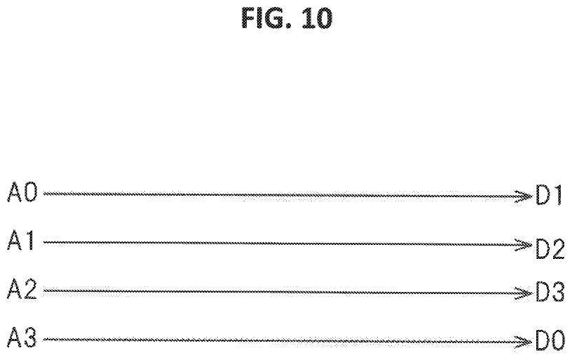

FIG. 10 is a diagram illustrating an example of the MLUT operating as a connection circuit. In FIG. 10, the MLUT as a connection circuit operates to output the signal of the address A0 to the output data D1, output the signal of the address A1 to the output data D2, and output the signal of the address A2 to the output data D3. The MLUT as a connection circuit further operates to output the signal of the address A3 to the output data D0.

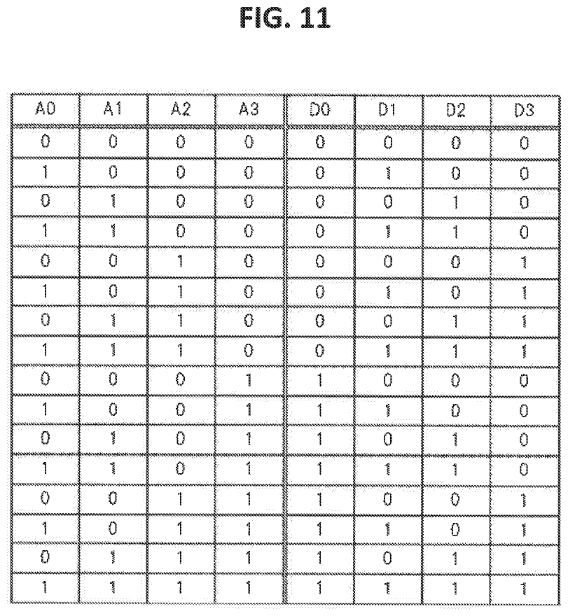

FIG. 11 is a diagram illustrating a truth table of the connection circuit shown in FIG. The connection circuit shown in FIG. 10 has four inputs and four outputs. Therefore, all the inputs of the addresses A0 to A3 and all the outputs of the output data D0 to D3 are used. According to the truth table shown in FIG. 11, the MLUT outputs the signal of the address A0 to the output data D1, the signal of the address A1 to the output data D2, and the signal of the address A2 to the output data D3, and the address A3. Operates as a connection circuit that outputs the signal of (1) to the output data D0.

C. Truth Table Data Constituting Logic Circuit and Connection Circuit

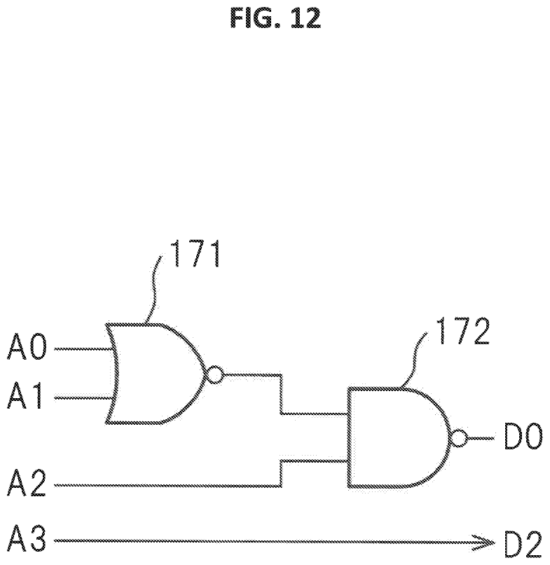

FIG. 12 is a diagram illustrating an example in which one MLUT operates as a logic circuit and a connection circuit. In the example shown in FIG. 12, the addresses A0 and A1 are input to the 2-input NOR circuit 171, the output of the 2-input NOR circuit 171 and the address A2 are input to the 2-input NAND circuit 172, and the output of the 2-input NAND circuit 172 Constitute a logic circuit that outputs the output data D0. At the same time, a connection circuit for outputting the signal of the address A3 to the output data D2 is configured.

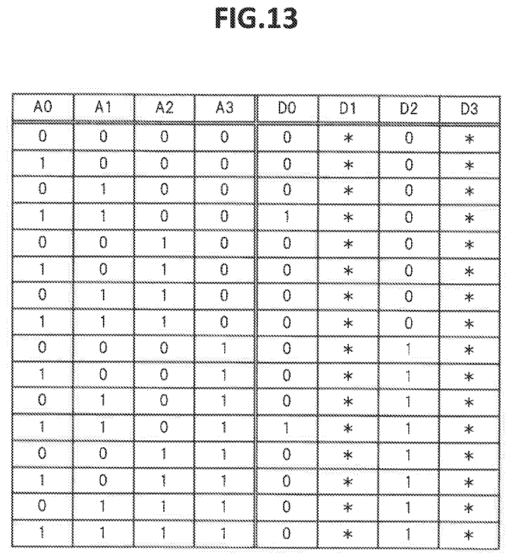

FIG. 13 illustrates a truth table of the logic circuit and the connection circuit shown in FIG. 12. The logic circuit of FIG. 12 uses three inputs of addresses A0 to A3 and uses one output data D0 as an output. On the other hand, a connection circuit for outputting the signal of the address A3 to the output data D2 is configured.

D. Sequential Circuit Function

The sequential circuit cannot describe its operation with the truth table data itself held in the MLUT like the combinational circuit. In the present embodiment, the sequential circuit is realized using the function of the output buffer 13. The D-type flip flop configures the following truth table with respect to the output of the memory cell unit operating in synchronization.

TABLE 1

| Output from D MLUT | Clock | Q for the next state |
|---|---|---|
| 0 | Rise | 0 |
| 1 | Rise | 1 |
| X | Fall | Keep Q of previous state |

The embodiments described above are merely typical examples, and the combinations, variations and variations of the components of the respective embodiments are apparent to those skilled in the art, and those skilled in the art can understand the principles and claims of the present invention. It will be appreciated that various modifications of the above-described embodiments can be made without departing from the scope of the described invention.

### DESCRIPTION OF SYMBOLS

20 Logic, MRLD
30 MLUT
60 Logic arrays
100 Resolver signal processing unit

1. An arithmetic processing device for resolver signal comprising:
an A/D converter for converting a rotation detection signal of a rotation detection sensor supplied from the outside into a digital signal; and
a logic unit constituting a logic circuit that calculates the angle of the rotation detection sensor from the digital signal output from the A/D converter,
wherein the amplifier, the A/D converter, and the logic unit are mounted in the same chip or in the same package.

2. The arithmetic processing device according to claim 1, comprising an excitation coil, a first detection coil and a second detection coil that detect a signal according to an excitation signal of the excitation coil, wherein the first and second detection coils have a 90° phase with each other offset and located around the excitation coil;
wherein the A/D converter converts an analog signal S1 transmitted from the first detection coil and an analog signal S2 generated from the second detection coil into a digital signal S1 and a digital signal S2, respectively; and
wherein the logic unit obtains the angle (θ) of the exciting coil with respect to the digital signals S1 and S2 according to the following equation (where t is time, f (t) is an excitation signal, and w is an angular velocity)
S1=sin θ·f(t)=sin θ·sin ωt
S2=cos θ·f(t)=cos θ·sin ωt
θ=tan−1(sin θ/cos θ).

3. The arithmetic processing device according to claim 1, further comprising an amplifier for amplifying the rotation detection signal with a designated gain,
wherein the logic unit transmits a signal for setting the designated gain to the amplifier in accordance with an analog signal voltage of a rotation detection sensor.

4. The arithmetic processing device according to claim 1, wherein the logic unit includes a plurality of address lines, a plurality of data lines, a memory cell unit, and an address decoder that decodes an address signal and outputs a decode signal to the memory cell unit.

5. The arithmetic processing device according to claim 1, wherein the memory cell unit controls or sets the amplification unit as a wiring element and/or a logic element configured by truth table data.

6. The arithmetic processing device according to claim 1, wherein the memory cell unit calculates an angle from a digital signal output from the A/D converter as a wiring element and/or a logic element configured by truth table data.

7. The arithmetic processing device according to claim 1, wherein the logic unit is a multi-lookup table.

8. The arithmetic processing device according to claim 2, further comprising an amplifier for amplifying the rotation detection signal with a designated gain,
wherein the logic unit transmits a signal for setting the designated gain to the amplifier in accordance with an analog signal voltage of a rotation detection sensor.

9. The arithmetic processing device according to claim 2, wherein the logic unit includes a plurality of address lines, a plurality of data lines, a memory cell unit, and an address decoder that decodes an address signal and outputs a decode signal to the memory cell unit.

10. The arithmetic processing device according to claim 3, wherein the logic unit includes a plurality of address lines, a plurality of data lines, a memory cell unit, and an address decoder that decodes an address signal and outputs a decode signal to the memory cell unit.

11. The arithmetic processing device according to claim 5, wherein the memory cell unit calculates an angle from a digital signal output from the A/D converter as a wiring element and/or a logic element configured by truth table data.

12. The arithmetic processing device according to claim 2, wherein the logic unit is a multi-lookup table.

13. The arithmetic processing device according to claim 3, wherein the logic unit is a multi-lookup table.

14. The arithmetic processing device according to claim 4, wherein the logic unit is a multi-lookup table.

15. The arithmetic processing device according to claim 5, wherein the logic unit is a multi-lookup table.

16. The arithmetic processing device according to claim 6, wherein the logic unit is a multi-lookup table.
